(19) United States
(12) Patent Application Publication
(10) Pub. No.: US 2026/0220648 A1
(43) Pub. Date: Jul. 30, 2026

(54) COMPLAINT INVESTIGATION

(71) Applicant: Honeywell International Inc., Charlotte, NC (US)

(72) Inventors: Waad Subber, Schenectady, NY (US); Ankit Singh, Apex, NC (US)

(21) Appl. No.: 19/037,292

(22) Filed: Jan. 27, 2025

(51) Int. Cl. G06Q 30/016; G06Q 10/0631

(52) U.S. Cl. CPC G06Q 30/016; G06Q 10/06316

(57) ABSTRACT

Approaches for conducting investigations in an organization are described. The approach includes obtaining domain expert (DE) data, including first set of domain specific questions indicative of investigative steps for conducting an investigation, corresponding to each of a plurality of domains. For each domain, the DE data and second set of domain specific questions are parsed to generate an investigation workflow to be followed for conducting the investigation. Second set of domain specific questions are contextually similar variations of the first set of domain specific questions. Investigation workflows associated with the plurality of domains are compiled to generate the instruction guide. An investigation model is trained to handle investigation requests by analyzing user complaints and the instruction guide. Once trained, the investigation model ascertains investigation workflow for investigating user complaint, implements the investigation workflow to initiate an investigation, and generates an investigation report for the user complaint based on the investigation.

### BACKGROUND

Investigations are often carried out by organizations to examine and address issues or concerns raised in relation to products and services offered by the organizations or processes implemented by the organizations. The investigations may be conducted across single domain or multiple domains for ensuring complete examination and addressal of any issue or concern. For example, in order to examine or address a user complaint related to a product, the investigation may be conducted in product quality domain to identify issues in the quality of the product, the investigation may also be conducted in manufacturing process domain to identify issues in the manufacturing process of the product, and the investigation may also be conducted in regulatory compliance domain to identify any deviation from standard regulations for the product. The issues and concerns, such as the user complaint, may originate from various sources, including customers, industry professionals, regulatory agencies, or internal quality control processes. Thus, conducting investigations across one or more domains is essential for organizations to maintain quality standards, ensure consumer and workforce safety, and comply with regulatory standards.

### BRIEF DESCRIPTION OF FIGURES

Systems and/or methods are now described, in accordance with examples of the present subject matter and with reference to the accompanying figures, in which:

FIG. 1 illustrates a system for training an investigation model for conducting one or more investigations to investigate user complaints in an organization, according to an example;

FIG. 2 illustrates a computing environment implementing the system for training the investigation model and investigating a user complaint using the investigation model, according to an example;

FIG. 3 illustrates a schematic diagram depicting an exemplary data flow for training an investigation model and investigating a user complaint using the investigation model, according to an example;

FIGS. 4A to 4C illustrate a method for training an investigation model for conducting one or more investigations to investigate user complaints in an organization, according to an example;

FIG. 5 illustrates a method for storing documents required for conducting one or more investigations to investigate user complaints in an organization, according to an example;

FIGS. 6A and 6B illustrate a method for investigating a user complaint using an investigation model, according to an example;

FIG. 7 illustrates a method for optimizing an investigation model for conducting one or more investigations to investigate user complaints in an organization, according to an example;

FIG. 8 illustrate a method for optimizing an investigation model for conducting one or more investigations to investigate user complaints in an organization, according to another example; and

FIG. 9 illustrates a computing environment implementing a non-transitory computer-readable medium for training an investigation model and investigating a user complaint using the investigation model, according to an example.

### DETAILED DESCRIPTION

Typically, organizations utilize an artificial intelligence model, such as a large language model (LLM), during an investigation procedure for examining and addressing complaints related to the organizations. However, LLMs solely depend on a prompt to responsively generate a response. The prompt is a set of instruction given to an LLM to generate a response. The quality and specificity of the prompt may significantly influence content of the generated response and coherence of text in the generated response. A well-crafted prompt provides comprehensive context of the input, such as a complaint, facilitating the production of a valuable response. Thus, prompts are typically crafted by data scientists having expertise in operating the LLM.

In numerous real-world applications, particularly in specialized industrial sectors, it is often crucial to involve a domain expert having expertise in a particular domain during the investigation procedure for examining and addressing issues or concerns. The domain expert plays a vital role in preparing complaint-specific instructions for guiding a data scientist to craft a prompt and configure an LLM so that the LLM can give relevant and helpful responses. The complaint-specific instructions, prepared by the domain expert, must clearly capture the essence of the information in the complaint and the essence of the problem that the LLM is expected to solve. Domain experts manually review the complaint, analyze relevant data for investigation in respective domains, and formulate the complaint-specific instructions based on their expertise in the respective domains. Thus, the quality of the complaint-specific instructions and the prompt affect results of the investigation procedure.

For accurately and precisely investigating complaints, clear and precise complaint-specific instructions and well-crafted prompts are needed from the domain expert and the data scientist for each complaint. Further, the collaboration between the human investigators, such as the domain experts and the data specialists, is crucial for harnessing the full potential of LLMs in the real-world applications. Despite the collaborative efforts between the domain experts and the data scientists, the reliance on human input introduces potential inconsistencies and subjective interpretations, which may impact the reliability and reproducibility of the results of the investigation procedure. As the volume of complaints increases, scaling the investigation procedure while maintaining quality becomes increasingly challenging. Further, maintaining a standardized approach across different investigations and investigators may be difficult.

Further, in case multiple investigations are required to be conducted across multiple domains for examining and addressing a complex complaint, inputs from multiple domain experts, having expertise in different domains, may be required for conducting separate investigations in relation to each domain. For example, in order to examine or address a user complaint related to a product, inputs from a domain expert having expertise in the product quality domain, another domain expert having expertise in the manufacturing process domain, and another domain expert having expertise in the regulatory compliance domain may be required for investigating the user complaint.

Engaging multiple domain experts for investigating each complaint can be time-consuming and expensive. The resource investment required for investigating the complaint escalates significantly when multiple domain experts need to be involved. The requirement of cross-disciplinary domain expertise makes it challenging to coordinate and synthesize information from various domain experts. This issue is further compounded by high number of complaints that need to be investigated in the organization. Moreover, access to the domain experts may be limited due to their scarcity or scheduling constraints, which adds to the delay in the investigation for the complaints. The involvement of multiple domain experts may also introduce unintended biases and subjective interpretations, potentially affecting the consistency of investigation outcomes. Thus, there is a need for an innovative solution that can augment and streamline the investigation procedure for investigating complaints in industrial settings, particularly for multi-domain investigation.

The present subject matter describes approaches for efficiently and accurately conducting investigations in an organization, particularly for resolving user complaints. In an example, the approach involves obtaining domain expert (DE) data, including first set of domain specific questions and documents, for each of a plurality of domains relevant for conducting investigations in the organization. The first set of domain specific questions may be indicative of investigative steps to be performed for conducting an investigation. The documents may be references that are to be referred for resolving the first set of domain specific questions. Rather than relying solely on domain experts to draft detailed complaint-specific instructions for every complaint, the DE data may be obtained from the domain experts once, to utilize the DE data for generating an instruction guide that may be utilized by an investigation model for conducting multi-domain investigations automatically for any future complaint. For generating the instruction guide, the corresponding DE data may be processed to generate contextually similar variations, i.e., second set of domain specific questions, of the first set of domain specific questions for each domain from among the plurality of domains. For each domain, the corresponding DE data and the second set of domain specific questions may then be parsed, using a query resolution model such as a large language model (LLM), to generate an investigation workflow to be followed for conducting the investigation. Investigation workflows associated with the plurality of domains may be compiled to generate the instruction guide. The investigation model may be trained to autonomously handle investigation requests by analyzing user complaints and the instruction guide. Once trained, the investigation model may ascertain an investigation workflow to be followed for investigating a user complaint, implement the investigation workflow to initiate an investigation, and generate an investigation report for the user complaint based on the investigation. The investigation report may include at least a root cause of the user complaint, determined by the pre-trained investigation model. The described automated approaches leverage domain expertise to create a versatile system capable of conducting multi-domain investigations in an organization, without actively involving the domain experts.

In an example, the documents may be initially analyzed to group the documents into one or more reference groups. Each of the one or more reference groups may include one or more documents, from amongst the documents, of a same reference type. For each reference group of the one or more reference groups, a vector embedding corresponding to the one or more documents associated with the reference group may be generated. The vector embedding associated with the one or more reference groups may be stored in at least one vector database. The vector embedding stored in the at least one vector database may be utilized for efficiently searching relevant data from the documents while conducting the multi-domain investigations initiated by the organization.

In an example, the investigation workflow may include chain-of-thoughts (COT) and actions to be performed in relation to each thought in the COT, for conducting the investigation. For generating the investigation workflow for each domain, for each question of the first set of domain specific questions and the second set of domain specific questions, the question and the documents may be parsed by the query resolution model to determine chain-of-thought (COT) data and action data.

The COT data may be indicative of chain-of-thoughts for generating a response to the question. Further, the action data may be indicative of actions to be performed, by the query resolution model, in relation to each thought of the chain-of-thoughts for generating the response to the question. The COT data and the action data associated with the first set of domain specific questions and the second set of domain specific questions may be processed to generate the investigation workflow to be followed for conducting the investigation.

The present subject matter thus leverages domain expert knowledge by collecting the documents and the domain specific questions which reflect cognitive approach of a domain expert while conducting any investigation in respective domain of the domain expert. The present subject matter thus follows a multi-query approach in which multiple variations of the original domain specific question provided by the domain expert are formulated by generating the second set of domain specific questions. Each variation of the original domain specific question offers a slightly different angle or perspective on the original domain specific question, enabling a more thorough exploration of the domain knowledge obtained from the domain expert for forming the investigation workflow. The multi-query approach ensures that even tangentially related information in the first set of domain specific questions and the documents is not overlooked in the process of the investigation.

Generating the investigation workflow for each domain and then compiling the investigation workflow associated with the plurality of domains to generate the instruction guide enables creation of a comprehensive, cross-disciplinary instruction guide for conducting multi-domain investigations. By forming a comprehensive, cross-disciplinary instruction guide, the present subject matter mitigates biases among the domain experts, and provides a standardized approach for addressing complex, multi-domain issues in organizations.

The present subject matter provides an intelligent investigation engine, integrating query resolution models such as the LLMs to streamline and automate investigation processes in organizations. Since the domain experts are not required to be compulsorily involved for every investigation, the present subject matter reduces the time, and the costs associated with handling multi-domain investigations and investigations related to complaints. The present subject matter can easily handle a large volume of investigations and complaints without compromising on the depth of investigation, making the technique highly scalable specially for industrial applications.

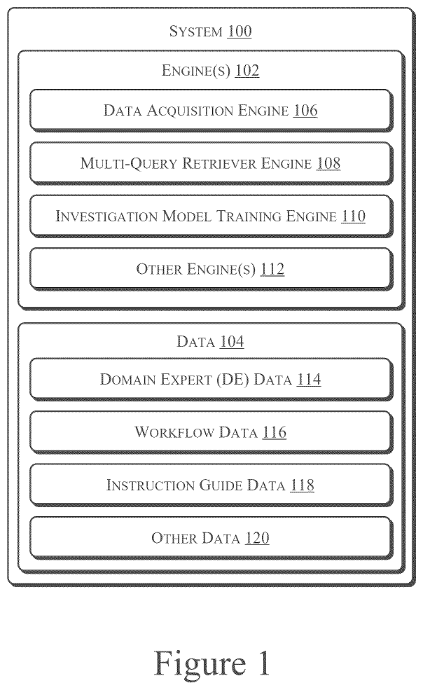

The present subject matter is further described with reference to FIGS. 1 to 8. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIG. 1 illustrates a system 100 for training an investigation model for conducting one or more investigations to investigate user complaints in an organization, according to an example. In one example, the system 100 may be a distributed computing system having one or more physical computing systems geographically distributed at same or different locations. In another example, one or more components of the system 100 may be hosted virtually, for example, on a cloud-based platform, while other components may be geographically distributed at same or different locations. In yet another example, the system 100 may be a stand-alone physical system geographically located at a particular location. In an example, the system 100 may be utilized by organizations for conducting single domain or multi-domain investigations, for example, for investigating the user complaints.

In one example, the system 100 may include engine(s) 102 and data 104. The system 100 may also include additional components, such as display, input/output interfaces, operating systems, applications, and other software or hardware components (not shown in the figures).

The engine(s) 102 may be implemented as a combination of hardware and programming, for example, programmable instructions to implement a variety of functionalities of the engine(s) 102. In examples described herein, such combinations of hardware and programming may be implemented in several different ways. For example, the programming for the engine(s) 102 may be executable instructions. Such instructions may be stored on a non-transitory machine-readable storage medium which may be coupled either directly with the system 100 or indirectly (for example, through networked means). In an example, the engine(s) 102 may include a processing resource, for example, either a single processor or a combination of multiple processors, to execute such instructions. In the present examples, the non-transitory machine-readable storage medium may store instructions that, when executed by the processing resource, implement the engine(s) 102. In other examples, the engine(s) 102 may be implemented as electronic circuitry.

In one example, the engine(s) 102 may include a data acquisition engine 106, a multi-query retriever engine 108, an investigation model training engine 110, and other engine(s) 112. The other engine(s) 112 may further implement functionalities that supplement functions performed by the system 100 or any of the engine(s) 102.

The data 104 includes data that is either received, stored, or generated as a result of functions implemented by any of the engine(s) 102 or the system 100. It may be further noted that information stored and available in the data 104 may be utilized by the engine(s) 102 for performing various functions of the system 100. The data 104 may include domain expert (DE) data 114, workflow data 116, instruction guide data 118, and other data 120. The DE data 114 may include information obtained from one or more domain experts associated with the organization. In an example, the information obtained from a domain expert may describe the approach of the domain expert while investigating issues in a particular domain in which the domain expert has deep knowledge and expertise. Examples of the domain may include, but are not limited to, product quality domain encompassing quality control for products associated with the organization, manufacturing process domain encompassing quality control for manufacturing processes of the products, and regulatory compliance domain encompassing controlling deviations from standard regulations for the products. The workflow data 116 may include structured approaches determined by the system 100 for conducting investigations within respective domains for which the DE data 114 is obtained from the domain experts. The instruction guide data 118 may include a comprehensive set of guidelines, generated by the system 100 using the DE data 114, for conducting multi-domain investigations. The other data 120 may include data that is either received, stored, or generated as a result of functions implemented by any of the engine(s) 102.

In operation, the data acquisition engine 106 may obtain domain expert (DE) data corresponding to each of a plurality of domains relevant for conducting one or more investigations in the organization. In an example, the DE data may be obtained from the one or more domain experts associated with the organization. In another example, the DE data may be pre-stored in a memory of the system 100 and may be obtained from the memory. The DE data may include a first set of domain specific questions for each domain from among the plurality of domains. The first set of domain specific questions may be indicative of investigative steps to be performed for conducting an investigation. Further, the DE data may include documents to be referred for resolving the first set of domain specific questions for each domain from among the plurality of domains. Thus, the DE data corresponding to a domain describes the approach followed by a domain expert and the documents referred by the domain expert for conducting investigations in the domain. In one example, the DE data may be stored as the DE data 114.

Once the DE data is obtained, for each domain, the multi-query retriever engine 108 may process the corresponding DE data to generate a second set of domain specific questions different from the first set of domain specific questions. The second set of domain specific questions may have a context similar to a context of the first set of domain specific questions. Thus, the second set of domain specific questions may be contextually similar variations of the first set of domain specific questions. In an example, the multi-query retriever engine 108 may implement a large language model (LLM) for generating the second set of domain specific questions. In another example, the multi-query retriever engine 108 may utilize natural language processing (NLP) models, including but not limited to transformer-based architectures, recurrent neural networks (RNNs), generative pre-trained models, or advanced language generation models, for generating the second set of domain specific questions. The NLP models may be capable of generating linguistically diverse yet semantically consistent variations of the first set of domain specific questions.

Subsequently, for each domain, the investigation model training engine 110 may parse the corresponding DE data and the second set of domain specific questions to generate an investigation workflow to be followed for conducting the investigation. In an example, the corresponding DE data and the second set of domain specific questions may be parsed using a query resolution model such as the LLM. The investigation workflow may include chain-of-thoughts (COT) and actions to be performed in relation to each thought in the COT, for conducting the investigation. For example, by analysing the corresponding DE data and the second set of domain specific questions, the query resolution model may determine that an example step of the investigation is to check if a particular complaint is reportable. The query resolution model may then determine that, for the example step of investigation, the COT may include a first thought “I need to understand the definition of reportability as per the complaints policy” and a second thought “I need to understand the provided complaint”. Further, for the example step of investigation, a first action to be performed in relation to the first thought may be “search for the definition of reportable complaint” and a second action to be performed in relation to the second thought may be “write a detailed summary for the provided complaint”. In one example, the investigation workflow associated with the plurality of domains may be stored as the workflow data 116.

The investigation model training engine 110 may then compile the investigation workflow associated with the plurality of domains to generate an instruction guide. In an example, the investigation workflow may be compiled using an LLM. In an example, either a same LLM or different LLMs may be utilized for generating the second set of domain specific questions for each domain, generating the investigation workflow for each domain, and generating the instruction guide. In an example, prompt engineering techniques may be utilized in conjunction with the LLM for generating an instruction guide. The instruction guide may be a comprehensive document that compiles and organizes the investigation workflows from multiple domains into a structured, coherent format. The instruction guide may serve as a standardized reference providing step-by-step procedures, chain-of-thoughts, and associated actions for conducting multi-domain investigations. In one example, the instruction guide may be stored as the instruction guide data 118.

The investigation model training engine 110 may train an investigation model for being utilized for conducting multi-domain investigations initiated by the organization. In an example, the investigation model may be a machine learning (ML) model, for example based on a transformer architecture, that may be specifically trained for conducting multi-domain investigations for the organization. The investigation model may be configured to utilize the instruction guide for conducting the multi-domain investigations. Thus, the present subject matter provide an intelligent investigation model that is capable of autonomously conducting multi-domain investigations, without a need for input from a domain expert for every investigation.

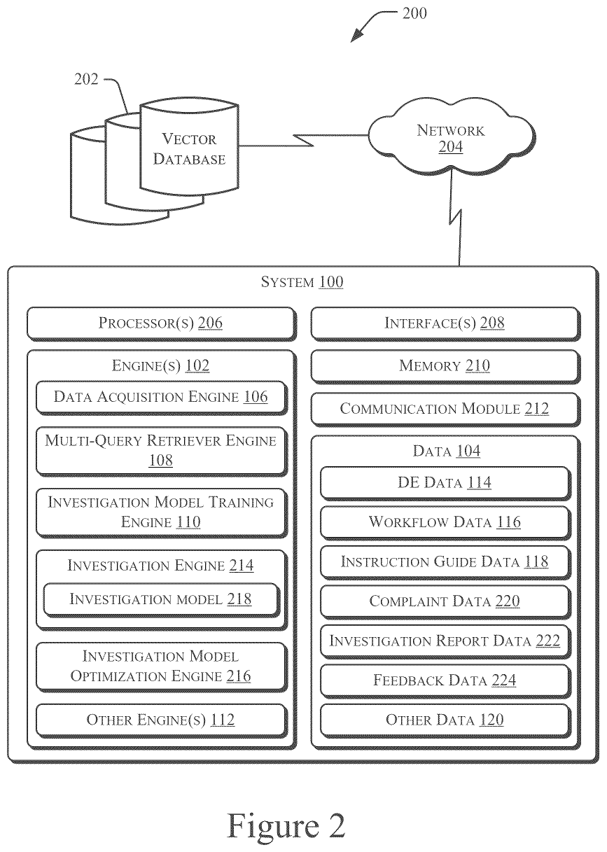

FIG. 2 illustrates a computing environment 200 implementing the system 100 for training an investigation model and investigating a user complaint using the investigation model, according to an example. In an example, the user complaint may relate to an issue or a concern raised in relation to products and services offered by an organization or processes implemented by the organization. In an example the user complaint may have originated from any of the sources, including customers, industry professionals, regulatory agencies, or internal quality control processes.

In one example, the computing environment 200 may include the system 100 and at least one vector database 202, interchangeably referred to as the vector database 202. The vector database 202 may store and manage vector embeddings of domain-specific documents and domain-specific data associated with the organization. Thus, the vector database 202 may enable rapid data search and rapid retrieval of contextually relevant information during the training of the investigation model and while investigating the user complaint. In an example, the vector database 202 may be a distributed computing system having one or more physical computing systems geographically distributed at same or different locations. In another example, one or more components of the vector database 202 may be hosted virtually, for example, on a cloud-based platform, while other components may be geographically distributed at same or different locations. In yet another example, the vector database 202 may be a stand-alone physical system geographically located at a particular location.

The system 100 and the vector database 202 may be communicably coupled with each other over a communication network 204 and may exchange data and signals over the communication network 204. The communication network 204 may be a wireless network, a wired network, or a combination thereof. The communication network 204 may also be an individual network or a collection of many such individual networks, interconnected with each other and functioning as a single large network, e.g., the Internet or an intranet. Examples of such individual networks include local area network (LAN), wide area network (WAN), the internet, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), and Integrated Services Digital Network (ISDN).

Depending on the technology, the communication network 204 may include various network entities, such as transceivers, gateways, and routers. In an example, the communication network 204 may include any communication network that uses any of the commonly used protocols, for example, Hypertext Transfer Protocol (HTTP), and Transmission Control Protocol/Internet Protocol (TCP/IP).

In one example, the system 100 may include processor(s) 206, interface(s) 208, memory 210, a communication module 212, the engine(s) 102, and the data 104. The system 100 may also include other components, such as display, input/output interfaces, operating systems, applications, and other software or hardware components (not shown in the figures).

The processor(s) 206 may be implemented as microprocessors, microcomputers, microcontrollers, digital signal processors, central processing units, state machines, logic circuitries, and/or other devices that manipulate signals based on operational instructions. The interface(s) 208 may allow the connection or coupling of the system 100 with one or more other devices, such as the vector database 202, through a wired (e.g., Local Area Network, i.e., LAN) connection or through a wireless connection (e.g., Bluetooth®, Wi-Fi). The interface(s) 208 may also enable intercommunication between different logical as well as hardware components of the system 100.

The memory 210 may be a computer-readable medium, examples of which include volatile memory (e.g., RAM), and/or non-volatile memory (e.g., Erasable Programmable read-only memory, i.e., EPROM, flash memory, etc.). The memory 210 may be an external memory or an internal memory, such as a flash drive, a compact disk drive, an external hard disk drive, or the like. The memory 210 may further include the data 104 and/or other data which may either be received, utilized, or generated during the operation of the system 100.

The communication module 212 may be a wireless communication module. Examples of the communication module 212 may include, but are not limited to, Global System for Mobile communication (GSM) modules, Code-division multiple access (CDMA) modules, Bluetooth modules, network interface cards (NIC), Wi-Fi modules, dial-up modules, Integrated Services Digital Network (ISDN) modules, Digital Subscriber Line (DSL) modules, and cable modules. In one example, the communication module 212 may also include one or more antennas to enable wireless transmission and reception of data and signals. The communication module 212 may allow the system 100 to transmit data and signals to one or more other devices, such as the vector database 202; and receive data and signals from the one or more other devices.

The engine(s) 102 may include the data acquisition engine 106, the multi-query retriever engine 108, the investigation model training engine 110, and the other engine(s) 112, as explained with reference to FIG. 1. In an example, the engine(s) 102 may further include an investigation engine 214 and an investigation model optimization engine 216. The investigation engine 214 may be configured to implement an investigation model 218 for investigating the user complaint. In an example, the investigation model 218 may be a machine learning (ML) model, for example, based on a transformer architecture, that may be specifically trained for conducting multi-domain investigations for the organization.

The data 104 may include the DE data 114, the workflow data 116, the instruction guide data 118, and the other data 120, as explained with reference to FIG. 1. In an example, the data 104 may further include complaint data 220, investigation report data 222, and feedback data 224. In an example, the complaint data 220 may include user complaints raised in relation to products and services offered by an organization or processes implemented by the organization. The investigation report data 222 may include investigation reports generated by the system 100 for the user complaints. The feedback data 224 may include user feedback, received from users associated with the organization, on the investigation reports. The feedback data 224 may also include domain expert feedback, received from domain experts on investigation guide generated by the system 100 for conducting multi-domain investigations.

In operation, for enabling the investigation engine 214 to conduct multi-domain investigations initiated by an organization, an investigation guide may be generated by the system 100. For generating the investigation guide, the data acquisition engine 106 may obtain domain expert (DE) data corresponding to each of a plurality of domains relevant for conducting one or more investigations in the organization. In an example, the DE data may be obtained from the one or more domain experts associated with the organization. In another example, the DE data may be pre-stored in the memory 210 of the system 100 and may be obtained from the memory 210. The DE data may include a first set of domain specific questions for each domain from among the plurality of domains. The first set of domain specific questions may be indicative of investigative steps to be performed for conducting an investigation. For example, a domain expert having expertise in manufacturing process domain may, while investigating a user complaint in the manufacturing process domain, usually check if the user complaint is reportable. Further, the domain expert may determine the severity level of the user complaint and the manufacturing processes that could be related to the user complaint. Further, the domain expert may determine if any change is to be made to any of the manufacturing processes based on the reportability of the user complaint and the severity level of the user complaint. Thus, the investigative steps that are usually taken by each of the one or more domain experts while conducting an investigation may be captured in the first set of domain specific questions, reflecting the thought process of the domain expert.

Further, the DE data may include documents to be referred for resolving the first set of domain specific questions for each domain from among the plurality of domains. For example, for checking if the user complaint is reportable, the domain expert may usually refer to a complaint manual defining conditions in which a complaint is reportable. Thus, the complaint manual may be one of the documents obtained along with the first set of domain specific questions. In an example, the investigative steps taken by the domain expert for conducting an investigation may be derived from insights and information learnt over time from the documents. Thus, the DE data corresponding to a domain may describe the approach followed by a domain expert and the documents referred by the domain expert for conducting investigations in the domain. In one example, the DE data may be stored as the DE data 114.

In an example, the documents may be stored in the vector database 202 in vectorized form for enabling efficient and quick search of contextually similar data. For storing the documents in the vector database 202, the investigation model training engine 110 may analyze the documents to group the documents into one or more reference groups. Each of the one or more reference groups may include one or more documents, from amongst the documents, of a same reference type. In an example, the one or more documents may belong to the same reference type depending on the domain to which the documents relate. For instance, documents related to “product quality” domain may be associated with one reference group, documents related to “manufacturing process” domain may be associated with another reference group, and documents related to “regulatory compliance” domain may be associated with yet another reference group. In another example, the one or more documents may belong to the same reference type depending on the type of respective document. For example, documents defining policies may be associated with one reference group, documents having guidelines may be associated with another reference group, and documents such as manuals may be associated with yet another reference group.

In an example, for each reference group of the one or more reference groups, the investigation model training engine 110 may generate a vector embedding corresponding to the one or more documents associated with the reference group. The investigation model training engine 110 may store the vector embedding associated with the one or more reference groups in the vector database 202. The vector embedding stored in the vector database 202 may be utilized for searching relevant data from the documents while conducting the multi-domain investigations initiated by the organization.

Once the DE data is obtained, for each domain, the multi-query retriever engine 108 may process the corresponding DE data to generate a second set of domain specific questions different from the first set of domain specific questions. The second set of domain specific questions may have a context similar to a context of the first set of domain specific questions. Thus, the second set of domain specific questions may be contextually-similar variations of the first set of domain specific questions. In an example, the multi-query retriever engine 108 may implement a large language model (LLM) for generating the second set of domain specific questions. In another example, the multi-query retriever engine 108 may utilize natural language processing (NLP) models, including but not limited to transformer-based architectures, recurrent neural networks (RNNs), generative pre-trained models, or advanced language generation models, for generating the second set of domain specific questions. The NLP models may be capable of generating linguistically diverse yet semantically consistent variations of the first set of domain specific questions.

In an example, for processing the corresponding DE data to generate the second set of domain specific questions for each domain, the multi-query retriever engine 108 may analyze the documents and the first set of domain specific questions to retrieve contextually matching data from the documents. The contextually matching data may have a context similar to the context of the first set of domain specific questions. In an example, the contextually matching data may be retrieved from the documents by conducting a search through the vector database 202 using vector matching techniques. The multi-query retriever engine 108 may then process the first set of domain specific questions and the contextually matching data to generate the second set of domain specific questions. In one example, for each question within the first set of domain specific questions, one or more contextually similar questions are generated as part of the second set of domain specific questions. For example, for an example question “is the provided complaint reportable” within the first set of domain specific questions, the second set of domain specific questions may include “retrieve documents from the vector database relevant to determining the reportability of the provided complaint”, “query the vector database for documents pertinent to assessing whether the given complaint should be reported”, and “explore documents in the vector database that can aid in determining if the complaint at hand requires reporting”. The second set of domain specific questions may thus have contextually similar, but more number of questions.

Subsequently, for each domain, the investigation model training engine 110 may parse the corresponding DE data and the second set of domain specific questions to generate an investigation workflow to be followed for conducting the investigation. In an example, the corresponding DE data and the second set of domain specific questions may be parsed using a query resolution model such as the LLM. The investigation workflow may include chain-of-thoughts (COT) and actions to be performed in relation to each thought in the COT, for conducting the investigation. For example, by analysing the corresponding DE data and the second set of domain specific questions, the query resolution model may determine that one of the steps of the investigation involves checking if a particular complaint is reportable. The query resolution model may then determine the COT that a domain expert may have while checking if the particular complaint is reportable. The query resolution model may also determine actions that may be performed by the domain expert in accordance to each thought in order to determine if the particular complaint is reportable. In one example, the investigation workflow associated with the plurality of domains may be stored as the workflow data 116.

In an example, for generating the investigation workflow for each domain, each question in the first set of domain specific questions and the second set of domain specific questions may be processed along with the documents. For example, for each question of the first set of domain specific questions and the second set of domain specific questions, the investigation model training engine 110 may parse the question and the documents by the query resolution model to determine chain-of-thought (COT) data and action data. The COT data may be indicative of chain-of-thoughts for generating a response to the question. Further, the action data may be indicative of actions to be performed, by the query resolution model, in relation to each thought of the chain-of-thoughts for generating the response to the question. For instance, for an example question “is the provided complaint reportable”, the COT data may include a first thought “I need to understand the definition of reportability as per the complaints policy” and a second thought “I need to understand the provided complaint”. Further, for the example question, a first action to be performed in relation to the first thought may be “search for the definition of reportable complaint” and a second action to be performed in relation to the second thought may be “write a detailed summary for the provided complaint”. Once the COT data and the action data are determined, the investigation model training engine 110 may process the COT data and the action data associated with the first set of domain specific questions and the second set of domain specific questions to generate the investigation workflow to be followed for conducting the investigation.

The investigation model training engine 110 may then compile the investigation workflow associated with the plurality of domains to generate an instruction guide. In an example, the investigation workflow may be compiled using an LLM. In an example, either a same LLM or different LLMs may be utilized for generating the second set of domain specific questions for each domain, generating the investigation workflow for each domain, and generating the instruction guide. In an example, prompt engineering techniques may be utilized in conjunction with the LLM for generating an instruction guide. The instruction guide may be a comprehensive document that compiles and organizes the investigation workflows from multiple domains into a structured, coherent format. The instruction guide may serve as a standardized reference providing step-by-step procedures, chain-of-thoughts, and associated actions for conducting multi-domain investigations. In one example, the instruction guide may be stored as the instruction guide data 118.

Once the instruction guide is generated based on the investigation workflow, the investigation model training engine 110 may train the investigation model 218 for being utilized for conducting multi-domain investigations initiated by the organization. In an example, the investigation model 218 may be a machine learning (ML) model, for example, based on a transformer architecture, that may be specifically trained for conducting multi-domain investigations for the organization. The investigation model 218 may be configured to utilize the instruction guide for conducting the multi-domain investigations. The investigation model 218 may be capable of autonomously conducting multi-domain investigations, without a need for input from a domain expert for every investigation.

In an example, once the instruction guide is generated based on the investigation workflow, the investigation model optimization engine 216 may obtain domain expert feedback on the instruction guide. The domain expert feedback may be obtained from each of the one or more domain experts associated with the plurality of domains. Thus, domain experts from diverse disciplines may offer distinct and specialized insights on the instruction guide, each contributing unique perspectives according to their respective areas of expertise, for improvisation of the instruction guide. In an example, the domain expert feedback may be obtained from the one or more domain experts associated with the organization. In another example, the domain expert feedback data may be pre-stored in the memory 210 of the system 100 and may be obtained from the memory 210.

Once the domain expert feedback is obtained, the investigation model optimization engine 216 may analyze the domain expert feedback to generate a final version of the instruction guide. Then, the investigation model optimization engine 216 may optimize the investigation model 218 for being utilized for conducting the multi-domain investigations. The investigation model 218 may utilize the final version of the instruction guide for conducting the multi-domain investigations.

Once the investigation model 218 is trained for conducting the multi-domain investigations, the investigation engine 214 may implement the investigation model 218 for conducting future investigations, for example for investigating user complaints.

In an example, the investigation engine 214 may receive an investigation request for investigating a user complaint. The investigation request may be initiated by a user associated with the organization. In an example, the user may use any electronic device, such as a laptop or a mobile device, to trigger investigation in relation to the user complaint. For example, upon receiving a call from a customer reporting a faulty product, a customer service representative associated with the organization may use the electronic device to submit the investigation request. Similarly, upon receiving a regulatory non-compliance notification from a regulatory agency, a compliance specialist of the organization may submit the investigation request using the electronic device. In one example, the user complaint may be stored as the complaint data 220.

Upon receiving the investigation request, the investigation engine 214 may analyze the user complaint and the instruction guide to ascertain a particular investigation workflow to be followed for investigating the user complaint. In an example, the user complaint and the instruction guide may be analyzed using the investigation model 218. For instance, for a user complaint related to a particular drug, the investigation engine 214 may examine the user complaint to extract key information, such as a name of the particular drug, batch number of a product batch in which the particular drug was manufactured, an issue reported regarding the particular drug, and adverse effects of the particular drug. Further, the investigation engine 214 may refer to the instruction guide to identify relevant investigation workflows for the particular drug based on the key information. Thus, based on the complaint analysis and instruction guide consultation, the investigation engine 214 may select the most appropriate workflow for investigating the user complaint.

Once the particular investigation workflow is ascertained, the investigation engine 214 may implement the particular investigation workflow to initiate an investigation in relation to the user complaint. In an example, the particular investigation workflow may be implemented using the investigation model 218. For implementing the particular investigation workflow, the investigation engine 214 may identify one or more actions to be performed for conducting the investigation in accordance with the particular investigation workflow. The investigation engine 214 may then execute the one or more actions to determine a root cause of the user complaint based on the investigation. In an example, the one or more actions may be executed using the investigation model 218. For example, using the investigation model 218, the investigation engine 214 may determine that a first step of the investigation is to check if a particular complaint is reportable. The investigation engine 214 may then determine that, for the first step of investigation, a first action to be performed is “search for the definition of reportable complaint” and a second action to be performed is “write a detailed summary for the provided complaint”. The investigation engine 214 may then execute the first action and the second action to complete the first step of the investigation. Similarly, the investigation engine 214 may complete implementation of the particular workflow by executing actions corresponding to every step of the investigation according to the particular investigation workflow. By executing the particular investigation workflow, the investigation engine 214 may be able to determine the root cause of the user complaint. For example, while investigating a user complaint received in terms of a regulatory non-compliance notification from a regulatory agency, it may be determined that a non-compliance occurred due to an issue with a manufacturing equipment associated with the organization.

Once the particular investigation workflow is implemented, the investigation engine 214 may generate an investigation report for the user complaint. The investigation report may include at least the root cause of the user complaint. In an example, the investigation report may be generated using the investigation model 218. In an example, the investigation report may provide a comprehensive overview of the user complaint, the root cause of the user complaint, and the necessary actions to be taken for addressing issues or concerns in the user complaint.

In an example, once the instruction report is generated, the investigation model optimization engine 216 may obtain user feedback for the investigation report. The user feedback may be obtained from a user, such as a quality control specialist, regulatory compliance specialist, a manufacturing manager, or a legal counsel, associated with the organization. In an example, the user feedback may be obtained from the user associated with the organization. In another example, the user feedback data may be pre-stored in the memory 210 of the system 100 and may be obtained from the memory 210.

Once the user feedback is obtained, the investigation model optimization engine 216 may analyze the user feedback to generate a final version of the instruction guide. Then, the investigation model optimization engine 216 may optimize the investigation model 218 for being utilized for conducting the multi-domain investigations. The investigation model 218 may utilize the final version of the instruction guide for conducting the multi-domain investigations. Thus, the investigation model 218 may be continuously improvised to improve the quality of investigation reports generated by the investigation engine 214. Thus, the present subject matter leverages domain expertise to create a versatile system capable of conducting multi-domain investigations in an organization, without actively involving the domain experts.

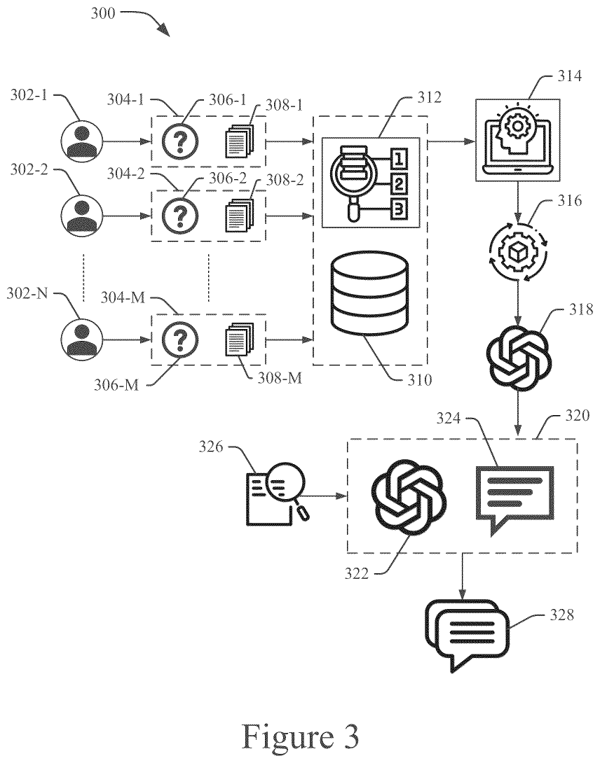

FIG. 3 illustrates a schematic diagram depicting an exemplary data flow 300 for training an investigation model and investigating a user complaint using the investigation model, according to an example.

The exemplary data flow 300 depicts domain experts 302-1, 302-2, . . . , 302-N associated with an organization, where N may be a natural number. The domain experts 302-1, 302-2, . . . , 302-N may be individually referred to as domain expert 302 and collectively referred to as domain experts 302. Although at least three domain experts 302-1, 302-2, . . . , 302-N have been depicted in FIG. 3, the present subject matter may be applicable to any number of domain experts equal to or greater than one. The domain expert 302 may have expertise in a particular domain. For instance, the domain expert 302-1 may be specialized in product quality domain encompassing quality control for products associated with the organization. Further, the domain expert 302-2 may be specialized in manufacturing process domain encompassing quality control for manufacturing processes of the products. Further, the domain expert 302-N may be specialized in regulatory compliance domain encompassing controlling deviations from standard regulations for the products. Thus, the domain experts 302 may together be experts in a plurality of domains.

For each domain of the plurality of domains, domain expert (DE) data 304-1, 304-2, . . . , 304-M may be obtained from the domain experts 302, where M may be a natural number. For instance, the DE data 304-1 may be obtained from the domain expert 302-1, the DE data 304-2 may be obtained from the domain expert 302-2, and the DE data 304-M may be obtained from the domain expert 302-N. The DE data 304-1, 304-2, . . . , 304-M may be individually referred to as corresponding DE data 304 and collectively referred to as DE data 304. While the corresponding DE data 304 has been described as being obtained from a single domain for each domain, the corresponding DE data 304 may also be obtained from multiple domain experts for the same domain.

The corresponding DE data 304 of each domain may include a first set of domain specific questions and documents to be referred for resolving the first set of domain specific questions. For instance, the corresponding DE data 304-1 may include the first set of domain specific questions 306-1 and the documents 308-1. The corresponding DE data 304-2 may include the first set of domain specific questions 306-2 and the documents 308-2. Further, the corresponding DE data 304-M may include the first set of domain specific questions 306-M and the documents 308-M. The first set of domain specific questions 306-1, 306-2, . . . , 306-M may be individually referred to as first set of domain specific questions 306 and collectively referred to as cluster of first set of domain specific questions 306. The documents 308-1, 308-2, . . . , 308-M may be individually referred to as documents 308 and collectively referred to as cluster of documents 308. The first set of domain specific questions 306 may be indicative of investigative steps to be performed for conducting an investigation. Thus, the first set of domain specific questions 306 may reflect the thought process of the domain expert 302, from whom the corresponding DE data 304 is obtained, while conducting an investigation in the particular domain of the domain expert 302. In an example, the cluster of documents 308 may be stored in a vector database 310 in vectorized form for enabling efficient and quick search of contextually similar data. That is, vector embeddings of the cluster of documents 308 may be stored in the vector database 310.

Once the DE data 304 is obtained, the corresponding DE data 304 of each domain may be processed by a multi-query retriever 312 to generate a second set of domain specific questions different from the first set of domain specific questions 306. The second set of domain specific questions may have a context similar to a context of the first set of domain specific questions 306. Thus, the second set of domain specific questions may be contextually similar variations of the first set of domain specific questions 306. In an example, the multi-query retriever 312 may implement a large language model (LLM) or natural language processing (NLP) models for generating the second set of domain specific questions. The LLM and the NLP models may be capable of generating linguistically diverse yet semantically consistent variations of the first set of domain specific questions 306. The multi-query retriever 312 may refer the cluster of documents 308 stored in vectorized form in the vector database 310 for generating contextually similar variations, i.e., the second set of domain specific questions, corresponding to the first set of domain specific questions 306.

The corresponding DE data 304 and the second set of domain specific questions of each domain may be parsed by a query resolution model 314 to generate an investigation workflow 316 to be followed for conducting the investigation. In an example, the query resolution model 314 may be an LLM or an NLP model. The investigation workflow 316 may include chain-of-thoughts (COT) and actions to be performed in relation to each thought in the COT, for conducting the investigation. In an example, the query resolution model 314 may access the vector database 310 to refer the cluster of documents 308 stored in vectorized form in the vector database 310 for generating the investigation workflow 316.

The investigation workflow 316 associated with each of the plurality of domains may be collected and compiled by an instruction generator 318 to generate an instruction guide 324. In an example, the instruction generator 318 may be an LLM or an NLP model. In an example, either a same LLM, NLP model or different LLMs, NLP models may be utilized for generating the second set of domain specific questions for each domain, generating the investigation workflow 316 for each domain, and generating the instruction guide 324. The instruction guide 324 may be a comprehensive document that compiles and organizes the investigation workflows from multiple domains into a structured, coherent format. The instruction guide 324 may serve as a standardized reference providing step-by-step procedures, chain-of-thoughts, and associated actions for conducting multi-domain investigations.

The exemplary data flow 300 depicts an investigation engine 320. The investigation engine 320 may include an investigation model 322 that may be configured to investigate user complaints using the instruction guide 324 obtained from the instruction generator 318. The investigation model 322 may be trained for being utilized for conducting multi-domain investigations initiated by an organization. In an example, the investigation model 322 may be a machine learning (ML) model, for example, based on a transformer architecture, or an LLM that may be specifically trained for conducting the multi-domain investigations for the organization.

Upon receiving an investigation request for investigating a user complaint 326, the investigation engine 320 may ascertain an investigation workflow to be followed for investigating the user complaint 326, implement the investigation workflow to initiate an investigation, and generate an investigation report 328 for the user complaint 326 based on the investigation. The investigation report 328 may include at least a root cause of the user complaint 326, determined by the investigation model 322. In an example, communication between different components, such as the multi-query retriever 312, the vector database 310, the query resolution model 314, the instruction generator 318, and the investigation engine 320 in the exemplary data flow 300 may be coordinated and managed by an orchestrator (not shown in the figures). The orchestrator may implement functionalities that supplement functions performed by the system 100. Thus, the present subject matter leverages domain expertise to create a versatile system capable of conducting multi-domain investigations in an organization, without actively involving the domain experts 302 for every investigation.

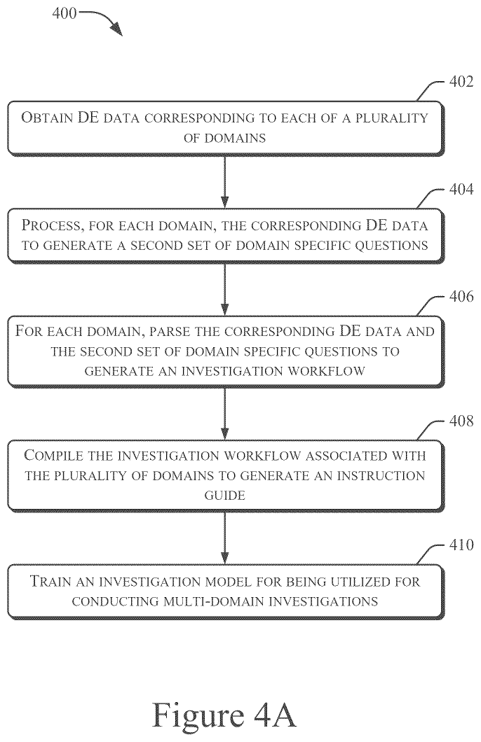

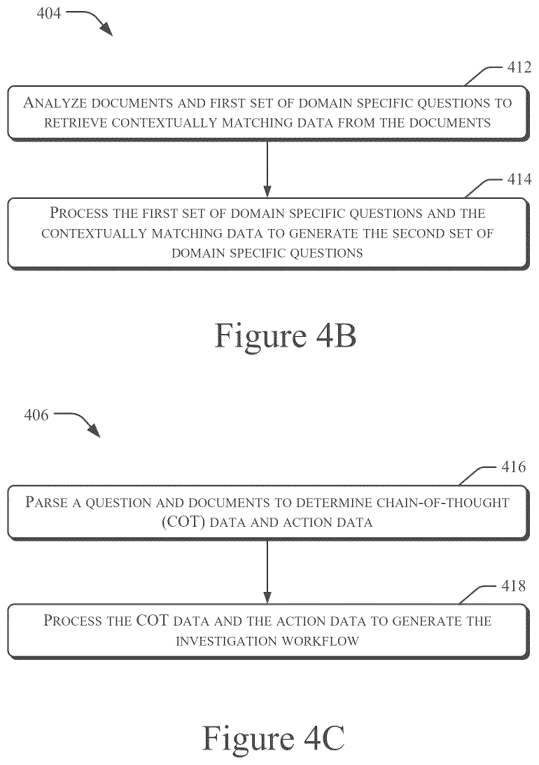

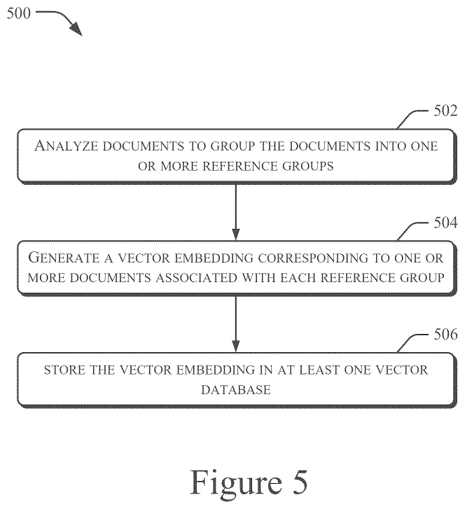

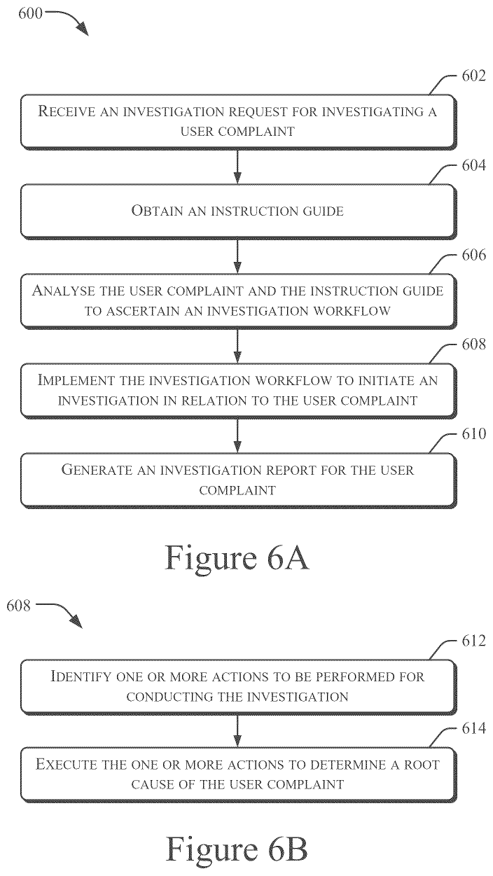

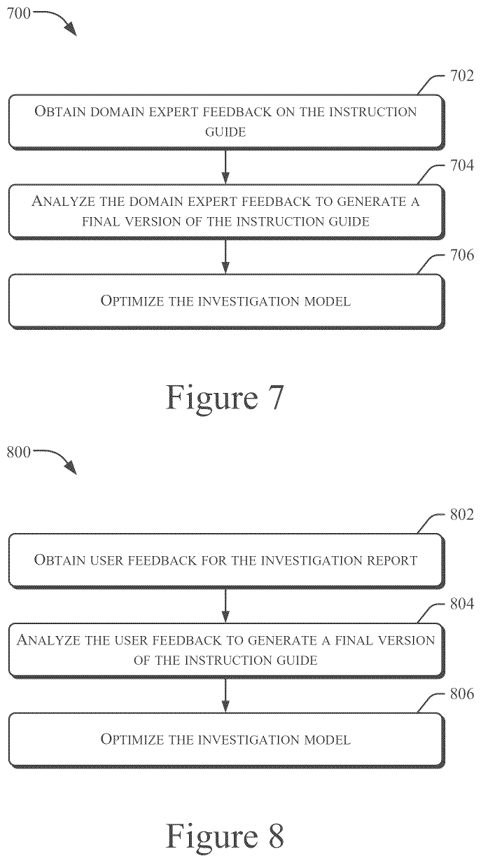

FIG. 4A, FIG. 4B, FIG. 4C, FIG. 5, FIG. 6A, FIG. 6B, FIG. 7, and FIG. 8 illustrate example methods 400, 404, 406, 500, 600, 608, 700, and 800, respectively, for training an investigation model, managing documents required for conducting one or more investigations in an organization, and investigating a user complaint using the investigation model. The order in which the methods are described is not intended to be construed as a limitation, and any number of the described method blocks may be combined in any order to implement the methods, or an alternative method. Further, the methods 400, 404, 406, 500, 600, 608, 700, and 800 may be implemented by processing resource or computing device(s) through any suitable hardware, non-transitory machine-readable instructions, or combination thereof.

It may also be understood that methods 400, 404, 406, 500, 600, 608, 700, and 800 may be performed by programmed computing devices, such as the system 100, as depicted in FIG. 1 and FIG. 2. Furthermore, the methods 400, 404, 406, 500, 600, 608, 700, and 800 may be executed based on instructions stored in a non-transitory computer-readable medium, as will be readily understood. The non-transitory computer-readable medium may include, for example, digital memories, magnetic storage media, such as one or more magnetic disks and magnetic tapes, hard drives, or optically readable digital data storage media. While the methods 400, 404, 406, 500, 600, 608, 700, and 800 are described below with reference to the system 100 as described above; other suitable systems for the execution of these methods may also be utilized. Additionally, implementation of the methods 400, 404, 406, 500, 600, 608, 700, and 800 is not limited to such examples.

FIG. 4A illustrates the method 400 for training an investigation model for conducting one or more investigations to investigate user complaints in an organization, according to an example.

At block 402, domain expert (DE) data corresponding to each of a plurality of domains relevant for conducting one or more investigations in the organization may be obtained. In an example, the DE data may be obtained from the one or more domain experts associated with the organization. In another example, the DE data may be pre-stored in a memory, say the memory 210, of the system 100 and may be obtained from the memory. The DE data may include a first set of domain specific questions for each domain from among the plurality of domains. The first set of domain specific questions may be indicative of investigative steps to be performed for conducting an investigation. Further, the DE data may include documents to be referred for resolving the first set of domain specific questions for each domain from among the plurality of domains. Thus, the DE data corresponding to a domain describes the approach followed by a domain expert and the documents referred by the domain expert for conducting investigations in the domain.

At block 404, for each domain, the corresponding DE data may be processed to generate a second set of domain specific questions different from the first set of domain specific questions. The second set of domain specific questions may have a context similar to a context of the first set of domain specific questions. Thus, the second set of domain specific questions may be contextually similar variations of the first set of domain specific questions. In an example, the second set of domain specific questions may be generated by implementing a large language model (LLM). In another example, the second set of domain specific questions may be generated by utilizing natural language processing (NLP) models, including but not limited to transformer-based architectures, recurrent neural networks (RNNs), generative pre-trained models, or advanced language generation models, for generating the second set of domain specific questions. The NLP models may be capable of generating linguistically diverse yet semantically consistent variations of the first set of domain specific questions.

At block 406, for each domain, the corresponding DE data and the second set of domain specific questions may be parsed to generate an investigation workflow to be followed for conducting the investigation. In an example, the corresponding DE data and the second set of domain specific questions may be parsed using a query resolution model such as the LLM. The investigation workflow may include chain-of-thoughts (COT) and actions to be performed in relation to each thought in the COT, for conducting the investigation. For example, by analysing the corresponding DE data and the second set of domain specific questions, it may be determines that an example step of the investigation is to check if a particular complaint is reportable. Then, it may be determined that, for the example step of investigation, the COT may include a first thought “I need to understand the definition of reportability as per the complaints policy” and a second thought “I need to understand the provided complaint”. Further, for the example step of investigation, a first action to be performed in relation to the first thought may be “search for the definition of reportable complaint” and a second action to be performed in relation to the second thought may be “write a detailed summary for the provided complaint”.

At block 408, the investigation workflow associated with the plurality of domains may be compiled to generate an instruction guide. In an example, the investigation workflow may be compiled using an LLM. In an example, either a same LLM or different LLMs may be utilized for generating the second set of domain specific questions for each domain, generating the investigation workflow for each domain, and generating the instruction guide. In an example, prompt engineering techniques may be utilized in conjunction with the LLM for generating an instruction guide. The instruction guide may be a comprehensive document that compiles and organizes the investigation workflows from multiple domains into a structured, coherent format. The instruction guide may serve as a standardized reference providing step-by-step procedures, chain-of-thoughts, and associated actions for conducting multi-domain investigations.

At block 410, an investigation model may be trained for being utilized for conducting multi-domain investigations initiated by the organization. In an example, the investigation model may be a machine learning (ML) model, for example based on a transformer architecture, that may be specifically trained for conducting multi-domain investigations for the organization. The investigation model may be configured to utilize the instruction guide for conducting the multi-domain investigations.

FIG. 4B illustrates the method 404 for processing the corresponding DE data to generate the second set of domain specific questions at block 404 of FIG. 4A, according to an example.

For generating the second set of domain specific questions, at block 412, the documents and the first set of domain specific questions may be analyzed to retrieve contextually matching data from the documents. The contextually matching data may have a context similar to the context of the first set of domain specific questions. In an example, the contextually matching data may be retrieved from the documents by conducting a search through a vector database, say the vector database 202, using vector matching techniques.

At block 414, the first set of domain specific questions and the contextually matching data may be processed to generate the second set of domain specific questions. In one example, for each question within the first set of domain specific questions, one or more contextually similar questions are generated as part of the second set of domain specific questions. For example, for an example question “is the provided complaint reportable” within the first set of domain specific questions, the second set of domain specific questions may include “retrieve documents from the vector database relevant to determining the reportability of the provided complaint”, “query the vector database for documents pertinent to assessing whether the given complaint should be reported”, and “explore documents in the vector database that can aid in determining if the complaint at hand requires reporting”. The second set of domain specific questions may thus have contextually similar, but more number of questions.

FIG. 4C illustrates the method 406 for parsing the corresponding DE data and the second set of domain specific questions for each domain to generate the investigation workflow at block 406 of FIG. 4A, according to an example.

For generating the investigation workflow for each domain, each question in the first set of domain specific questions and the second set of domain specific questions may be processed along with the documents. For instance, at block 416, for each question of the first set of domain specific questions and the second set of domain specific questions, the question and the documents may be parsed by the query resolution model to determine chain-of-thought (COT) data and action data. The COT data may be indicative of chain-of-thoughts for generating a response to the question. Further, the action data may be indicative of actions to be performed, by the query resolution model, in relation to each thought of the chain-of-thoughts for generating the response to the question. For instance, for an example question “is the provided complaint reportable”, the COT data may include a first thought “I need to understand the definition of reportability as per the complaints policy” and a second thought “I need to understand the provided complaint”. Further, for the example question, a first action to be performed in relation to the first thought may be “search for the definition of reportable complaint” and a second action to be performed in relation to the second thought may be “write a detailed summary for the provided complaint”.

Once the COT data and the action data are determined, at block 418, the COT data and the action data associated with the first set of domain specific questions and the second set of domain specific questions may be processed to generate the investigation workflow to be followed for conducting the investigation. Thus, the present subject matter provide an intelligent investigation model that is capable of autonomously conducting multi-domain investigations, without a need for input from a domain expert for every investigation.

FIG. 5 illustrates the method 500 for storing documents required for conducting one or more investigations to investigate user complaints in an organization, according to an example. The documents may be included in domain expert (DE) data, corresponding to each of a plurality of domains relevant for conducting one or more investigations in the organization, obtained from one or more domain experts associated with the organization or from the memory of the system 100, as explained at block 402 of FIG. 4A. The documents may be stored in a vector database, say the vector database 202, in vectorized form for enabling efficient and quick search of contextually similar data.

For storing the documents in the vector database, at block 502, the documents may be analyzed to group the documents into one or more reference groups. Each of the one or more reference groups may include one or more documents, from amongst the documents, of a same reference type. In an example, the one or more documents may belong to the same reference type depending on the domain to which the documents relate. For instance, documents related to “product quality” domain may be associated with one reference group, documents related to “manufacturing process” domain may be associated with another reference group, and documents related to “regulatory compliance” domain may be associated with yet another reference group. In another example, the one or more documents may belong to the same reference type depending on the type of respective document. For example, documents defining policies may be associated with one reference group, documents having guidelines may be associated with another reference group, and documents such as manuals may be associated with yet another reference group.

At block 504, for each reference group of the one or more reference groups, a vector embedding may be generated corresponding to the one or more documents associated with the reference group.

At block 506, the vector embedding associated with the one or more reference groups may be stored in at least one vector database, say the vector database 202. The vector embedding stored in the at least one vector database may be utilized for searching relevant data from the documents while conducting the multi-domain investigations initiated by the organization.

FIG. 6A illustrates the method 600 for investigating a user complaint using an investigation model, say the investigation model 218, according to an example. The investigation model, hereinafter alternatively referred to as the pre-trained investigation model, may be trained for being utilized for conducting multi-domain investigations initiated by an organization, according to the method 400 of FIGS. 4A to 4C. In an example, the investigation model may be a machine learning (ML) model, for example based on a transformer architecture, that may be specifically trained for conducting multi-domain investigations for the organization.

At block 602, an investigation request may be received for investigating a user complaint. The investigation request may be initiated by a user associated with the organization. In an example, the user may use any electronic device, such as a laptop or a mobile device, to trigger investigation in relation to the user complaint. For example, upon receiving a call from a customer reporting a faulty product, a customer service representative associated with the organization may use the electronic device to submit the investigation request. Similarly, upon receiving a regulatory non-compliance notification from a regulatory agency, a compliance specialist of the organization may submit the investigation request using the electronic device.

At block 604, an instruction guide may be obtained by the pre-trained investigation model. The instruction guide may define one or more investigation workflows for conducting multi-domain investigation. The instruction guide may be generated based on analysis of domain expert (DE) data indicative of investigative steps to be performed for conducting one or more investigations across a plurality of domains, according to method 400 of FIGS. 4A to 4C.

At block 606, the user complaint and the instruction guide may be analyzed to ascertain a particular investigation workflow to be followed for investigating the user complaint. In an example, the user complaint and the instruction guide may be analyzed using the pre-trained investigation model. For instance, for a user complaint related to a particular drug, the user complaint may be examined to extract key information, such as a name of the particular drug, batch number of a product batch in which the particular drug was manufactured, an issue reported regarding the particular drug, and adverse effects of the particular drug. Further, the instruction guide may be referred to identify relevant investigation workflows for the particular drug based on the key information. Thus, based on the complaint analysis and instruction guide consultation, the most appropriate workflow may be selected for investigating the user complaint.

At block 608, the particular investigation workflow may be implemented to initiate an investigation in relation to the user complaint. In an example, the particular investigation workflow may be implemented using the pre-trained investigation model.

At block 610, an investigation report may be generated for the user complaint. The investigation report may include at least the root cause of the user complaint. In an example, the investigation report may be generated using the pre-trained investigation model. In an example, the investigation report may provide a comprehensive overview of the user complaint, the root cause of the user complaint, and the necessary actions to be taken for addressing issues or concerns in the user complaint.

FIG. 6B illustrates the method 608 for implementing the particular investigation workflow at block 608 of FIG. 6A, according to an example.

For implementing the particular investigation workflow, at block 612, one or more actions to be performed for conducting the investigation may be identified in accordance with the particular investigation workflow. For example, using the pre-trained investigation model, it may be determined that a first step of the investigation is to check if a particular complaint is reportable. Then, it may be determined that, for the first step of investigation, a first action to be performed is “search for the definition of reportable complaint” and a second action to be performed is “write a detailed summary for the provided complaint”.

At block 614, the one or more actions may be executed to determine a root cause of the user complaint based on the investigation. In an example, the one or more actions may be executed using the pre-trained investigation model. For example, the first action and the second action to complete the first step of the investigation may be executed. Similarly, the implementation of the particular workflow may be completed by executing actions corresponding to every step of the investigation according to the particular investigation workflow. By executing the particular investigation workflow, the root cause of the user complaint may be determined. For example, while investigating a user complaint received in terms of a regulatory non-compliance notification from a regulatory agency, it may be determined that a non-compliance occurred due to an issue with a manufacturing equipment associated with the organization.

FIG. 7 illustrates the method 700 for optimizing an investigation model, say the investigation model 218, for conducting one or more investigations to investigate user complaints in an organization, according to an example.

At block 702, domain expert feedback on an instruction guide may be obtained. The instruction guide may be generated based on analysis of domain expert (DE) data indicative of investigative steps to be performed for conducting one or more investigations across a plurality of domains, according to method 400 of FIGS. 4A to 4C. The domain expert feedback may be obtained from each of one or more domain experts associated with the plurality of domains. Thus, domain experts from diverse disciplines may offer distinct and specialized insights on the instruction guide, each contributing unique perspectives according to their respective areas of expertise, for improvisation of the instruction guide. In an example, the domain expert feedback may be obtained from the one or more domain experts associated with the organization. In another example, the domain expert feedback data may be pre-stored in the memory of the system 100 and may be obtained from the memory.

At block 704, the domain expert feedback may be analyzed to generate a final version of the instruction guide. In an example, analyzing the domain expert feedback may include identifying relevant domain expert inputs that may be used to optimize the instruction guide and revising the instruction guide based on the domain expert inputs to generate the final version of the instruction guide.

At block 706, the investigation model may be optimized for being utilized for conducting the multi-domain investigations. The investigation model may utilize the final version of the instruction guide for conducting the multi-domain investigations. The optimized investigation model may be implemented for conducting future investigations, for example for investigating user complaints.

FIG. 8 illustrates the method 800 for optimizing an investigation model, say the investigation model 218, for conducting one or more investigations to investigate user complaints in an organization, according to an example.

At block 802, user feedback for an investigation report may be obtained. The investigation report may be generated by implementing the investigation model that utilizes an investigation report for generating the investigation report. The investigation report may be generated based on analysis of domain expert (DE) data indicative of investigative steps to be performed for conducting one or more investigations across a plurality of domains, according to method 400 of FIGS. 4A to 4C. The user feedback may be obtained from a user, such as a quality control specialist, regulatory compliance specialist, a manufacturing manager, or a legal counsel, associated with the organization. In an example, the user feedback may be obtained from the user associated with the organization. In another example, the user feedback data may be pre-stored in the memory of the system 100 and may be obtained from the memory.

At block 804, the user feedback may be analyzed to generate a final version of the instruction guide. In an example, analyzing the user feedback may include identifying relevant user inputs that may be used to optimize the instruction guide and revising the instruction guide based on the user inputs to generate the final version of the instruction guide.

At block 806, the investigation model may be optimized for being utilized for conducting the multi-domain investigations. The investigation model may utilize the final version of the instruction guide for conducting the multi-domain investigations. The optimized investigation model may be implemented for conducting future investigations, for example for investigating user complaints. Thus, the investigation model may be continuously improvised to improve the quality of investigation reports generated using the investigation model.

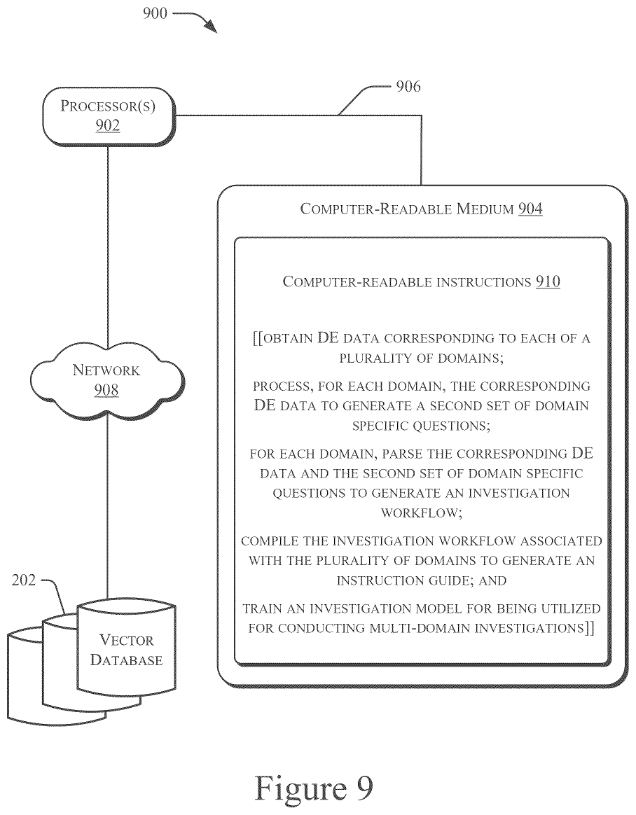

FIG. 9 illustrates a computing environment 900 implementing a non-transitory computer-readable medium for training an investigation model and investigating a user complaint using the investigation model, according to an example. In an example, the computing environment 900 includes processor(s) 902 communicatively coupled to a non-transitory computer-readable medium 904 through a communication link 906. In one example, the communication link 906 may be similar to the communication network 204, as described in conjunction with the preceding figures. In an example implementation, the computing environment 900 may be for example, the computing environment 200. In an example, the processor(s) 902 may have one or more processing resources for fetching and executing computer-readable instructions from the non-transitory computer-readable medium 904. The processor(s) 902 and the non-transitory computer-readable medium 904 may be implemented, for example, in the system 100 (as has been described in conjunction with the preceding figures).

The non-transitory computer-readable medium 904 may be, for example, an internal memory device or an external memory device. In an example implementation, the communication link 906 may be a network communication link. The processor(s) 902 and the non-transitory computer-readable medium 904 may also be communicatively coupled to the vector database 202 over a network 908. The network 908 may be similar to the communication network 204 described in conjunction with FIG. 2.

In an example implementation, the non-transitory computer-readable medium 904 may include a set of computer-readable instructions 910 which may be accessed by the processor(s) 902 through the communication link 906. Referring to FIG. 9, in an example, the non-transitory computer-readable medium 904 may include instructions 910 that may cause the processor(s) 902 to obtain domain expert (DE) data corresponding to each of a plurality of domains relevant for conducting one or more investigations in the organization. In an example, the DE data may be obtained from one or more domain experts associated with the organization. In another example, the DE data may be pre-stored in a memory, say the memory 210, of the system 100 and may be obtained from the memory. The DE data may include a first set of domain specific questions for each domain from among the plurality of domains. The first set of domain specific questions may be indicative of investigative steps to be performed for conducting an investigation. For example, a domain expert having expertise in manufacturing process domain may, while investigating a user complaint in the manufacturing process domain, usually check if the user complaint is reportable. Further, the domain expert may determine the severity level of the user complaint and the manufacturing processes that could be related to the user complaint. Further, the domain expert may determine if any change is to be made to any of the manufacturing processes based on the reportability of the user complaint and the severity level of the user complaint. Thus, the investigative steps that are usually taken by each of the one or more domain experts while conducting an investigation may be captured in the first set of domain specific questions, reflecting the thought process of the domain expert.

Further, the DE data may include documents to be referred for resolving the first set of domain specific questions for each domain from among the plurality of domains. For example, for checking if the user complaint is reportable, the domain expert may usually refer to a complaint manual defining conditions in which a complaint is reportable. Thus, the complaint manual may be one of the documents obtained along with the first set of domain specific questions. In an example, the investigative steps taken by the domain expert for conducting an investigation may be derived from insights and information learnt over time from the documents. Thus, the DE data corresponding to a domain may describe the approach followed by a domain expert and the documents referred by the domain expert for conducting investigations in the domain.

In an example, the documents may be stored in the vector database 202 in vectorized form for enabling efficient and quick search of contextually similar data. For storing the documents in the vector database 202, the instructions 910 may cause the processor(s) 902 to analyze the documents to group the documents into one or more reference groups. Each of the one or more reference groups may include one or more documents, from amongst the documents, of a same reference type. In an example, the one or more documents may belong to the same reference type depending on the domain to which the documents relate. For instance, documents related to “product quality” domain may be associated with one reference group, documents related to “manufacturing process” domain may be associated with another reference group, and documents related to “regulatory compliance” domain may be associated with yet another reference group. In another example, the one or more documents may belong to the same reference type depending on the type of respective document. For example, documents defining policies may be associated with one reference group, documents having guidelines may be associated with another reference group, and documents such as manuals may be associated with yet another reference group.

In an example, for each reference group of the one or more reference groups, the instructions 910 may cause the processor(s) 902 to generate a vector embedding corresponding to the one or more documents associated with the reference group. The instructions 910 may further cause the processor(s) 902 to store the vector embedding associated with the one or more reference groups in the vector database 202. The vector embedding stored in the vector database 202 may be utilized for searching relevant data from the documents while conducting the multi-domain investigations initiated by the organization.

In one example, once the DE data is obtained, for each domain, the instructions 910 may cause the processor(s) 902 to process the corresponding DE data to generate a second set of domain specific questions different from the first set of domain specific questions. The second set of domain specific questions may have a context similar to a context of the first set of domain specific questions. Thus, the second set of domain specific questions may be contextually-similar variations of the first set of domain specific questions. In an example, a large language model (LLM) may be implemented for generating the second set of domain specific questions. In another example, natural language processing (NLP) models, including but not limited to transformer-based architectures, recurrent neural networks (RNNs), generative pre-trained models, or advanced language generation models, may be utilized for generating the second set of domain specific questions. The NLP models may be capable of generating linguistically diverse yet semantically consistent variations of the first set of domain specific questions.

In an example, for processing the corresponding DE data to generate the second set of domain specific questions for each domain, the instructions 910 may cause the processor(s) 902 to analyze the documents and the first set of domain specific questions to retrieve contextually matching data from the documents. The contextually matching data may have a context similar to the context of the first set of domain specific questions. In an example, the contextually matching data may be retrieved from the documents by conducting a search through the vector database 202 using vector matching techniques. The instructions 910 may then cause the processor(s) 902 to process the first set of domain specific questions and the contextually matching data to generate the second set of domain specific questions. In one example, for each question within the first set of domain specific questions, one or more contextually similar questions are generated as part of the second set of domain specific questions. For example, for an example question “is the provided complaint reportable” within the first set of domain specific questions, the second set of domain specific questions may include “retrieve documents from the vector database relevant to determining the reportability of the provided complaint”, “query the vector database for documents pertinent to assessing whether the given complaint should be reported”, and “explore documents in the vector database that can aid in determining if the complaint at hand requires reporting”. The second set of domain specific questions may thus have contextually similar, but more number of questions.

Subsequently, for each domain, the instructions 910 may cause the processor(s) 902 to parse the corresponding DE data and the second set of domain specific questions to generate an investigation workflow to be followed for conducting the investigation. In an example, the corresponding DE data and the second set of domain specific questions may be parsed using a query resolution model such as the LLM. The investigation workflow may include chain-of-thoughts (COT) and actions to be performed in relation to each thought in the COT, for conducting the investigation. For example, by analysing the corresponding DE data and the second set of domain specific questions, the query resolution model may determine that one of the steps of the investigation involves checking if a particular complaint is reportable. The query resolution model may then determine the COT that a domain expert may have while checking if the particular complaint is reportable. The query resolution model may also determine actions that may be performed by the domain expert in accordance to each thought in order to determine if the particular complaint is reportable.

In an example, for generating the investigation workflow for each domain, each question in the first set of domain specific questions and the second set of domain specific questions may be processed along with the documents. For example, for each question of the first set of domain specific questions and the second set of domain specific questions, the instructions 910 may cause the processor(s) 902 to parse the question and the documents by the query resolution model to determine chain-of-thought (COT) data and action data. The COT data may be indicative of chain-of-thoughts for generating a response to the question. Further, the action data may be indicative of actions to be performed, by the query resolution model, in relation to each thought of the chain-of-thoughts for generating the response to the question. For instance, for an example question “is the provided complaint reportable”, the COT data may include a first thought “I need to understand the definition of reportability as per the complaints policy” and a second thought “I need to understand the provided complaint”. Further, for the example question, a first action to be performed in relation to the first thought may be “search for the definition of reportable complaint” and a second action to be performed in relation to the second thought may be “write a detailed summary for the provided complaint”.

Once the COT data and the action data are determined, the instructions 910 may cause the processor(s) 902 to process the COT data and the action data associated with the first set of domain specific questions and the second set of domain specific questions to generate the investigation workflow to be followed for conducting the investigation.

The instructions 910 may further cause the processor(s) 902 to compile the investigation workflow associated with the plurality of domains to generate an instruction guide. In an example, the investigation workflow may be compiled using an LLM. In an example, either a same LLM or different LLMs may be utilized for generating the second set of domain specific questions for each domain, generating the investigation workflow for each domain, and generating the instruction guide. In an example, prompt engineering techniques may be utilized in conjunction with the LLM for generating an instruction guide. The instruction guide may be a comprehensive document that compiles and organizes the investigation workflows from multiple domains into a structured, coherent format. The instruction guide may serve as a standardized reference providing step-by-step procedures, chain-of-thoughts, and associated actions for conducting multi-domain investigations.

The instructions 910 may further cause the processor(s) 902 to train an investigation model, say the investigation model 218, for being utilized for conducting multi-domain investigations initiated by the organization. In an example, the investigation model may be a machine learning (ML) model, for example, based on a transformer architecture, that may be specifically trained for conducting multi-domain investigations for the organization. The investigation model may be configured to utilize the instruction guide for conducting the multi-domain investigations. The investigation model may be capable of autonomously conducting multi-domain investigations, without a need for input from a domain expert for every investigation.

In an example, once the instruction guide is generated based on the investigation workflow, the instructions 910 may cause the processor(s) 902 to may obtain domain expert feedback on the instruction guide. The domain expert feedback may be obtained from each of the one or more domain experts associated with the plurality of domains. Thus, domain experts from diverse disciplines may offer distinct and specialized insights on the instruction guide, each contributing unique perspectives according to their respective areas of expertise, for improvisation of the instruction guide. In an example, the domain expert feedback may be obtained from the one or more domain experts associated with the organization. In another example, the domain expert feedback data may be pre-stored in the memory of the system 100 and may be obtained from the memory.

The instructions 910 may further cause the processor(s) 902 to analyze the domain expert feedback to generate a final version of the instruction guide. The instructions 910 may further cause the processor(s) 902 to optimize the investigation model for being utilized for conducting the multi-domain investigations. The investigation model may utilize the final version of the instruction guide for conducting the multi-domain investigations. Once the investigation model is trained for conducting the multi-domain investigations, the investigation model may be implemented for conducting future investigations, for example for investigating user complaints.

In one example, the instructions 910 may further cause the processor(s) 902 to receive an investigation request for investigating a user complaint. The investigation request may be initiated by a user associated with the organization. In an example, the user may use any electronic device, such as a laptop or a mobile device, to trigger investigation in relation to the user complaint. For example, upon receiving a call from a customer reporting a faulty product, a customer service representative associated with the organization may use the electronic device to submit the investigation request. Similarly, upon receiving a regulatory non-compliance notification from a regulatory agency, a compliance specialist of the organization may submit the investigation request using the electronic device.

Upon receiving the investigation request, the instructions 910 may cause the processor(s) 902 to analyze the user complaint and the instruction guide to ascertain a particular investigation workflow to be followed for investigating the user complaint. In an example, the user complaint and the instruction guide may be analyzed using the investigation model. For instance, for a user complaint related to a particular drug, the user complaint may be examined to extract key information, such as a name of the particular drug, batch number of a product batch in which the particular drug was manufactured, an issue reported regarding the particular drug, and adverse effects of the particular drug. Further, the instruction guide may be referred to identify relevant investigation workflows for the particular drug based on the key information. Thus, based on the complaint analysis and instruction guide consultation, the most appropriate workflow may be selected for investigating the user complaint.

Once the particular investigation workflow is ascertained, the instructions 910 may cause the processor(s) 902 to implement the particular investigation workflow to initiate an investigation in relation to the user complaint. In an example, the particular investigation workflow may be implemented using the investigation model. For implementing the particular investigation workflow, the instructions 910 may cause the processor(s) 902 to identify one or more actions to be performed for conducting the investigation in accordance with the particular investigation workflow. The instructions 910 may further cause the processor(s) 902 to execute the one or more actions to determine a root cause of the user complaint based on the investigation. In an example, the one or more actions may be executed using the investigation model. For example, using the investigation model, it may be determined that a first step of the investigation is to check if a particular complaint is reportable. Further, it may be determined that, for the first step of investigation, a first action to be performed is “search for the definition of reportable complaint” and a second action to be performed is “write a detailed summary for the provided complaint”. The first action and the second action may be executed to complete the first step of the investigation. Similarly, the implementation of the particular workflow may be completed by executing actions corresponding to every step of the investigation according to the particular investigation workflow. By executing the particular investigation workflow, the root cause of the user complaint may be determined. For example, while investigating a user complaint received in terms of a regulatory non-compliance notification from a regulatory agency, it may be determined that a non-compliance occurred due to an issue with a manufacturing equipment associated with the organization.

Once the particular investigation workflow is implemented, the instructions 910 may cause the processor(s) 902 to generate an investigation report for the user complaint. The investigation report may include at least the root cause of the user complaint. In an example, the investigation report may be generated using the investigation model. In an example, the investigation report may provide a comprehensive overview of the user complaint, the root cause of the user complaint, and the necessary actions to be taken for addressing issues or concerns in the user complaint.

In one example, the instructions 910 may further cause the processor(s) 902 to obtain user feedback for the investigation report. The user feedback may be obtained from a user, such as a quality control specialist, regulatory compliance specialist, a manufacturing manager, or a legal counsel, associated with the organization. In an example, the user feedback may be obtained from the user associated with the organization. In another example, the user feedback data may be pre-stored in the memory of the system 100 and may be obtained from the memory.

The instructions 910 may further cause the processor(s) 902 to analyze the user feedback to generate a final version of the instruction guide. Then, the instructions 910 may further cause the processor(s) 902 to optimize the investigation model for being utilized for conducting the multi-domain investigations. The investigation model may utilize the final version of the instruction guide for conducting the multi-domain investigations. Thus, the investigation model may be continuously improvised to improve the quality of investigation reports generated by the investigation model. Thus, the present subject matter leverages domain expertise to create a versatile system capable of conducting multi-domain investigations in an organization, without actively involving the domain experts.

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

We claim:

1. A system comprising:
a data acquisition engine to:
obtain domain expert (DE) data corresponding to each of a plurality of domains relevant for conducting one or more investigations in an organization, wherein, for each domain from among the plurality of domains, the DE data comprises:
a first set of domain specific questions indicative of investigative steps to be performed for conducting an investigation; and
documents to be referred for resolving the first set of domain specific questions;
a multi-query retriever engine to:
process, for each domain, the corresponding DE data to generate a second set of domain specific questions different from the first set of domain specific questions, the second set of domain specific questions having a context similar to a context of the first set of domain specific questions; and
an investigation model training engine to:
for each domain, parse, using a query resolution model, the corresponding DE data and the second set of domain specific questions to generate an investigation workflow to be followed for conducting the investigation, the investigation workflow including chain-of-thoughts (COT) and actions to be performed in relation to each thought in the COT, for conducting the investigation;
compile the investigation workflow associated with the plurality of domains to generate an instruction guide; and
train an investigation model for being utilized for conducting multi-domain investigations initiated by the organization, wherein the investigation model is to utilize the instruction guide for conducting the multi-domain investigations.

2. The system of claim 1, wherein the system comprises:
an investigation engine to:
receive an investigation request for investigating a user complaint;
analyze, using the investigation model, the user complaint and the instruction guide to ascertain a particular investigation workflow to be followed for investigating the user complaint;
implement, using the investigation model, the particular investigation workflow to initiate an investigation in relation to the user complaint, wherein to implement the particular investigation workflow, the investigation engine is to:
identify one or more actions to be performed for conducting the investigation in accordance with the particular investigation workflow; and
execute, using the investigation model, the one or more actions to determine a root cause of the user complaint based on the investigation; and
generate, using the investigation model, an investigation report for the user complaint, the investigation report including at least the root cause of the user complaint.

3. The system of claim 1, wherein the investigation model training engine is to:
analyze the documents to group the documents into one or more reference groups, wherein each of the one or more reference groups includes one or more documents, from amongst the documents, of a same reference type;
for each reference group of the one or more reference groups, generate a vector embedding corresponding to the one or more documents associated with the reference group; and
store the vector embedding associated with the one or more reference groups in at least one vector database for being utilized for searching relevant data from the documents while conducting the multi-domain investigations initiated by the organization.

4. The system of claim 1, wherein the system comprises:
an investigation model optimization engine to:
obtain domain expert feedback on the instruction guide, from each of one or more domain experts associated with the plurality of domains;
analyze the domain expert feedback to generate a final version of the instruction guide; and
optimize the investigation model for being utilized for conducting the multi-domain investigations, wherein the investigation model is to utilize the final version of the instruction guide for conducting the multi-domain investigations.

5. The system of claim 2, wherein the system comprises:
an investigation model optimization engine to:
obtain, from a user associated with the organization, user feedback for the investigation report;
analyze the user feedback to generate a final version of the instruction guide; and
optimize the investigation model for being utilized for conducting the multi-domain investigations, wherein the investigation model is to utilize the final version of the instruction guide for conducting the multi-domain investigations.

6. The system of claim 1, wherein to process the corresponding DE data for generating the second set of domain specific questions for each domain, the multi-query retriever engine is to:
analyze the documents and the first set of domain specific questions to retrieve contextually matching data from the documents, the contextually matching data having a context similar to the context of the first set of domain specific questions; and
process the first set of domain specific questions and the contextually matching data to generate the second set of domain specific questions, wherein for each question within the first set of domain specific questions, one or more contextually similar questions are generated as part of the second set of domain specific questions.

7. The system of claim 1, wherein to parse the DE data and the second set of domain specific questions for generating the investigation workflow for each domain, the investigation model training engine is to:
for each question of the first set of domain specific questions and the second set of domain specific questions, parse, by the query resolution model, the question and the documents to determine:
chain-of-thought (COT) data indicative of chain-of-thoughts for generating a response to the question; and
action data indicative of actions to be performed, by the query resolution model, in relation to each thought of the chain-of-thoughts for generating the response to the question; and
process the COT data and the action data associated with the first set of domain specific questions and the second set of domain specific questions to generate the investigation workflow to be followed for conducting the investigation.

8. A method comprising:
receiving an investigation request for investigating a user complaint;
obtaining, by a pre-trained investigation model, an instruction guide defining one or more investigation workflows for conducting multi-domain investigation, the instruction guide being generated based on analysis of domain expert (DE) data indicative of investigative steps to be performed for conducting one or more investigations across a plurality of domains;
analysing, by the pre-trained investigation model, the user complaint and the instruction guide to ascertain an investigation workflow to be followed for investigating the user complaint;
implementing, by the pre-trained investigation model, the investigation workflow to initiate an investigation in relation to the user complaint; and
generating, by the pre-trained investigation model, an investigation report for the user complaint based on the investigation, the investigation report including at least a root cause of the user complaint, determined by the pre-trained investigation model.

9. The method of claim 8, wherein implementing the investigation workflow comprises:
identifying one or more actions to be performed for conducting the investigation in accordance with the investigation workflow; and
executing, using the pre-trained investigation model, the one or more actions to determine the root cause of the user complaint based on the investigation.

10. The method of claim 8, wherein the method comprises:
obtaining, from a user, user feedback for the investigation report;
analysing the user feedback to generate a final version of the instruction guide; and
optimizing the pre-trained investigation model for being utilized for conducting the multi-domain investigation, wherein the investigation model is to utilize the final version of the instruction guide for conducting the multi-domain investigation.

11. The method of claim 8, wherein the method comprises:
obtaining the DE data corresponding to each of the plurality of domains, wherein, for each domain from among the plurality of domains, the DE data comprises:
a first set of domain specific questions indicative of the investigative steps to be performed for conducting the one or more investigations; and
documents to be referred for resolving the first set of domain specific questions;
processing, for each domain, the corresponding DE data to generate a second set of domain specific questions different from the first set of domain specific questions, the second set of domain specific questions having a context similar to a context of the first set of domain specific questions;
for each domain, parsing, using a query resolution model, the DE data and the second set of domain specific questions to generate an investigation workflow to be followed for conducting the one or more investigations, the investigation workflow including chain-of-thoughts (COT) and actions to be performed in relation to each thought in the COT, for conducting the one or more investigations;
compiling the investigation workflow associated with the plurality of domains to generate the instruction guide; and
training an investigation model to obtain the pre-trained investigation model for being utilized for conducting the multi-domain investigation.

12. The method of claim 11, wherein the method comprises:
analysing the documents to group the documents into one or more reference groups, wherein each of the one or more reference groups includes one or more documents, from amongst the documents, of a same reference type;
for each reference group of the one or more reference groups, generating a vector embedding corresponding to the one or more documents associated with the reference group; and
storing the vector embedding associated with the one or more reference groups in at least one vector database for being utilized for searching relevant data from the documents while conducting the multi-domain investigation.

13. The method of claim 11, wherein parsing the DE data and the second set of domain specific questions for generating the investigation workflow for each domain comprises:
for each question of the first set of domain specific questions and the second set of domain specific questions, parsing, by the query resolution model, the question and the documents to determine:
chain-of-thought (COT) data indicative of chain-of-thoughts for generating a response to the question; and
action data indicative of actions to be performed, by the query resolution model, in relation to each thought of the chain-of-thoughts for generating the response to the question; and
processing the COT data and the action data associated with the first set of domain specific questions and the second set of domain specific questions to generate the investigation workflow to be followed for conducting the one or more investigations.

14. A non-transitory computer-readable medium comprising instructions for conducting one or more investigations to investigate user complaints in an organization, the instructions being executable by a processing resource to:
obtain domain expert (DE) data corresponding to each of a plurality of domains relevant for conducting one or more investigations in an organization, wherein, for each domain from among the plurality of domains, the DE data comprises:
a first set of domain specific questions indicative of investigative steps to be performed for conducting an investigation; and
documents to be referred for resolving the first set of domain specific questions;
process, for each domain, the corresponding DE data to generate a second set of domain specific questions different from the first set of domain specific questions, the second set of domain specific questions having a context similar to a context of the first set of domain specific questions;
for each domain, parse, using a query resolution model, the corresponding DE data and the second set of domain specific questions to generate an investigation workflow to be followed for conducting the investigation, the investigation workflow including chain-of-thoughts (COT) and actions to be performed in relation to each thought in the COT, for conducting the investigation;
compile the investigation workflow associated with the plurality of domains to generate an instruction guide; and
train an investigation model for being utilized for conducting multi-domain investigations initiated by the organization, wherein the investigation model is to utilize the instruction guide for conducting the multi-domain investigations.

15. The non-transitory computer-readable medium of claim 14, wherein the instructions are executable by the processing resource to:
receive an investigation request for investigating a user complaint;
analyze, using the investigation model, the user complaint and the instruction guide to identify a particular investigation workflow to be followed for investigating the user complaint;
implement, using the investigation model, the particular investigation workflow to initiate an investigation in relation to the user complaint, wherein to implement the particular investigation workflow, the instructions are executable by the processing resource to:
identify one or more actions to be performed for conducting the investigation in accordance with the particular investigation workflow; and
execute, using the investigation model, the one or more actions to determine a root cause of the user complaint based on the investigation; and
generate, using the investigation model, an investigation report for the user complaint, the investigation report including at least the root cause of the user complaint.

16. The non-transitory computer-readable medium of claim 14, wherein the instructions are executable by the processing resource to:
analyze the documents to group the documents into one or more reference groups, wherein each of the one or more reference groups includes one or more documents, from amongst the documents, of a same reference type;
for each reference group of the one or more reference groups, generate a vector embedding corresponding to the one or more documents associated with the reference group; and
store the vector embedding associated with the one or more reference groups in at least one vector database for being utilized for searching relevant data from the documents while conducting the multi-domain investigations initiated by the organization.

17. The non-transitory computer-readable medium of claim 14, wherein the instructions are executable by the processing resource to:
obtain domain expert feedback on the instruction guide, from each of one or more domain experts associated with the plurality of domains;
analyze the domain expert feedback to generate a final version of the instruction guide; and
optimize the investigation model for being utilized for conducting the multi-domain investigations, wherein the investigation model is to utilize the final version of the instruction guide for conducting the multi-domain investigations.

18. The non-transitory computer-readable medium of claim 14, wherein the instructions are executable by the processing resource to:
obtain, from a user associated with the organization, user feedback for the investigation report;
analyze the user feedback to generate a final version of the instruction guide; and
optimize the investigation model for being utilized for conducting the multi-domain investigations, wherein the investigation model is to utilize the final version of the instruction guide for conducting the multi-domain investigations.

19. The non-transitory computer-readable medium of claim 14, wherein to process the corresponding DE data for generating the second set of domain specific questions for each domain, the instructions are executable by the processing resource to:
analyze the documents and the first set of domain specific questions to retrieve contextually matching data from the documents, the contextually matching data having a context similar to the context of the first set of domain specific questions; and
process the first set of domain specific questions and the contextually matching data to generate the second set of domain specific questions, wherein for each question within the first set of domain specific questions, one or more contextually similar questions are generated as part of the second set of domain specific questions.

20. The non-transitory computer-readable medium of claim 14, wherein to parse the DE data and the second set of domain specific questions for generating the investigation workflow for each domain, the instructions are executable by the processing resource to:
for each question of the first set of domain specific questions and the second set of domain specific questions, parse, by the query resolution model, the question and the documents to determine:
chain-of-thought (COT) data indicative of chain-of-thoughts for generating a response to the question; and
action data indicative of actions to be performed, by the query resolution model, in relation to each thought of the chain-of-thoughts for generating the response to the question; and
process the COT data and the action data associated with the first set of domain specific questions and the second set of domain specific questions to generate the investigation workflow to be followed for conducting the investigation.
